(19) United States
(12) Patent Application Publication
(10) Pub. No.: US 2023/0264145 A1
(43) Pub. Date: Aug. 24, 2023

(54) Improving the purity of a CO2-rich stream

(71) Applicant: TOPSOE A/S, Kgs. Lyngby (DK)

(72) Inventors: Per Juul DAHL, Vedbæk (DK); Morten GHILADI, Roskilde (DK); Arunabh SAHAI, Faridabad, Haryana (IN); Johannes SKOTTE, Farum (DK)

(73) Assignee: TOPSOE A/S, Kgs. Lyngby (DK)

(21) Appl. No.: 18/006,929

(22) PCT Filed: Sep. 20, 2021
(86) PCT No.: PCT/EP2021/075794

§ 371 Date: Jan. 26, 2023

(30) Foreign Application Priority Data
Sep. 21, 2020 (IN) 202011040821
Dec. 8, 2020 (DK) PA 2020 01381

(51) Int. Cl. B01D 53/75; C01B 32/50; C01B 3/48; C01B 3/52; B01D 53/26; B01D 53/14; B01D 53/86

(52) U.S. Cl. CPC B01D 53/75; B01D 53/1425; B01D 53/1475; B01D 53/265; B01D 53/864; C01B 3/48; C01B 3/52; C01B 32/50; B01D 2251/102; B01D 2256/16; B01D 2256/22; B01D 2257/502; B01D 2257/702; B01D 2257/80; C01B 2203/0244; C01B 2203/0283; C01B 2203/0415; C01B 2203/0475; C01B 2203/0811; C01B 2210/0021; C01B 2210/0062

(57) ABSTRACT

A process and plant for producing a high purity CO₂ product, comprising: providing a CO₂-rich stream containing hydrocarbons, hydrogen and/or CO, combining it with a stream rich in methane (CH₄), and mixing it with oxygen, thereby forming a CO₂/O₂- mixture; subjecting the CO₂/O₂- mixture to a catalytic oxidation step, thereby producing a purified stream having a higher CO₂ and/or H₂O concentration; removing H₂O from said purified stream, for producing said high purity CO₂ product stream. The CO₂-rich stream is for instance derived from the CO₂-removal section of a plant for producing hydrogen.

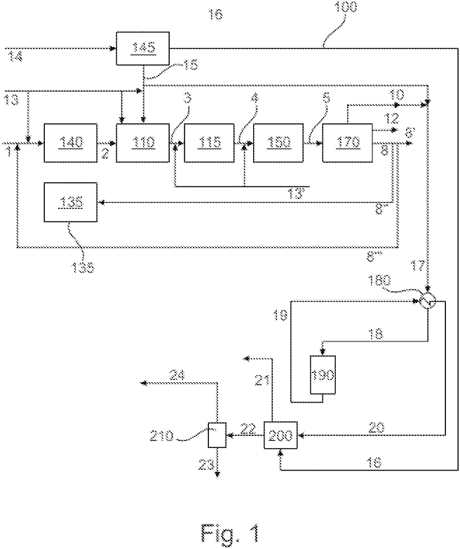

The present invention relates to a process and plant for improving the purity of a stream rich in CO₂ such as a CO₂-rich stream containing hydrocarbons, hydrogen and/or CO, from a CO₂ removal unit, e.g. in a plant or process for producing hydrogen. More specifically, the present invention relates to a process and plant for producing a high purity CO₂ product by catalytic oxidation (CATOX) of a CO₂-rich stream containing hydrocarbons, hydrogen and/or CO. The invention relates also to a process and plant for producing hydrogen from a hydrocarbon feed, in which the hydrocarbon feed is subjected to reforming in an optional pre-reformer and an autothermal reformer (ATR) for generating a synthesis gas, subjecting the synthesis gas to water gas shift conversion in a shift section for enriching the synthesis gas in hydrogen, subjecting the shifted gas to a carbon dioxide removal step whereby said CO₂-rich stream is produced as well as a H₂-rich stream, and optionally where at least a portion of the H₂-rich stream is used as low carbon hydrogen fuel, for instance in a fired heater used to preheat the hydrocarbon feed. The invention further relates to the use of a CATOX unit for purifying a CO₂-rich stream containing hydrocarbons, hydrogen and/or CO, derived from a hydrogen producing plant while not increasing the carbon emission of the plant.

There is an increasing demand for hydrogen plants capable of providing a high purity of the CO₂-rich stream withdrawn from a CO₂ removal section and at the same time a high carbon recovery. Thus, it would be desirable to be able to provide a process and plant for the production of hydrogen, which is capable of producing a CO₂-product of high purity e.g. as high as 99.99% CO₂ or even higher, while keeping a carbon recovery of at least 95%. In particular, the production of so-called “blue hydrogen”, whereby hydrogen is produced from a hydrocarbon feed such as natural gas and carbon dioxide is captured, requires a carbon recovery in the hydrogen process/plant of at least 95%.

In the production of hydrogen, the process includes subjecting the hydrocarbon feed to steam reforming, followed by water gas shift (WGS) as well as CO₂-removal in a CO₂-removal section. The CO₂ stream from CO₂ removal section often contains small amount of impurities such as H₂, H₂O, MeOH (methanol), CH₄, CO and inerts e.g. Ar. A conventional simple amine absorption of CO₂ followed with amine regeneration by pressure reduction and heating, i.e. an amine wash unit, gives also a CO₂ stream with high amount of impurities. The impurities from the CO₂-removal section are carried over in the so-called high-pressure flash gas (HP flash gas). The HP flash gas containing the impurities is exported or burned in fired heaters which e.g. preheat the hydrocarbon feed during reforming. However, this increases CO₂ emissions and has a negative impact on carbon recovery.

To improve carbon dioxide purity, a rich amine solution from the CO₂ absorber in the CO₂ removal section can be (de)pressurized in steps such as a high-pressure flash step in a high-pressure flash drum, followed by a low-pressure flash step in a low-pressure flash drum. In the first high pressure flash step the bulk part of the impurities are released together with some CO₂ to the gas phase as a high-pressure flash gas. In the low-pressure flash step, mainly CO₂ is released to a final product as a CO₂-rich stream. The rich amine solution is regenerated with heat in the CO₂ regeneration releasing more CO₂ to the CO₂-rich stream. Since much of the impurities are released in the high-pressure flash gas from the high-pressure flash drum, the CO₂-rich stream comes out with an increased purity such as > 98 vol%, for instance 98.5 or 99 vol.% CO₂, yet it will still contain impurities, mainly H₂, and minor amounts of carbon containing compounds in particular CH₄ and CO. It would be desirable to further improve the purity of the CO₂-rich stream to 99.9 or 99.99 vol.% CO₂ or even higher.

US 2017/0152219 A1 describes a method for manufacturing urea. Synthesis gas from a partial oxidation step is conducted to a water gas shift step for forming a shifted synthesis gas stream, which is then separated into first and second synthesis gas substreams. The first sub-stream is subjected to pressure swing adsorption to generate hydrogen, and the second sub-stream is subjected to temperature swing adsorption to generate carbon dioxide. The hydrogen is reacted with nitrogen to form ammonia, which is then reacted with the carbon dioxide to form urea. In an embodiment, impurities in the CO₂ separated in the temperature swing adsorption are removed by catalytic oxidation upstream of the reaction of CO₂ with the ammonia to form urea.

EP 2281775 A1 describes a process for the production of hydrogen and carbon dioxide utilizing a co-purge pressure swing adsorption unit. A pressure swing adsorption unit in conjunction with a carbon dioxide purification unit such as a cryogenic unit or a catalytic oxidizer are used to treat synthesis gas from an optional water gas shift reactor.

Purified carbon dioxide from the carbon dioxide purification unit is recycled for use as co-feed/co-purge of the adsorbent beds of the pressure swing adsorption unit, thereby producing a carbon dioxide tail gas having a higher CO₂ concentration.

There is a need to provide an alternative process and plant that enables a simpler solution for increasing the purity of a CO₂-rich stream, particularly in a process and plant for producing hydrogen.

It is therefore an object of the present invention to provide an alternative process and plant for improving the purity of a CO₂-rich stream, i.e. to further increase the CO₂-concentration therein, thereby obtaining a high purity CO₂ product.

It is another object of the present invention to improve the purity of the CO₂-rich stream, i.e. to further increase the CO₂-concentration therein, thereby obtaining a high purity CO₂ product, in a process and plant for producing hydrogen while avoiding the increase of CO₂ emissions and maintaining a carbon recovery in the plant of at least 95%.

These and other objects are solved by the present invention.

Accordingly, in a first aspect, the invention is a process for producing a high purity CO₂ product, comprising the steps of:
i) providing a CO₂-rich stream containing hydrocarbons, hydrogen and/or CO; combining it with a stream rich in methane (CH₄), such as a natural gas stream; and mixing it with oxygen, thereby forming a CO₂/O₂-mixture;
ii) subjecting the CO₂/O₂-mixture to a catalytic oxidation step, thereby producing a purified stream having a higher CO₂ and/or H₂O concentration, i.e. higher CO₂ and/or H₂O concentration than in the CO₂-rich stream prior to or after combining with the stream rich in methane, or in the CO₂/O₂-mixture;
iii) removing H₂O from said purified stream, for producing said high purity CO₂ product.

As used herein, the term “catalytic oxidation”, as is well known in the art, is used interchangeably with its acronym CATOX and means the oxidation of combustible impurities in the CO₂-rich stream such as H₂, H₂O, MeOH, CH₄, CO and inerts e.g. Ar, over a catalyst in the presence of oxygen.

The catalyst(s) in the CATOX step can be selected from tungsten, vanadium, molybdenum, platinum and palladium in metallic and/or in metal oxide form supported on a carrier; or from vanadium, tungsten, chromium, copper, manganese, molybdenum, platinum, palladium, rhodium or ruthenium in metallic and/or metal oxide form supported on a carrier selected from alumina, titania, silica and ceria and combinations thereof.

Operating temperatures in the CATOX step are in the range 100-600° C., such as 150-400° C. or 200-350° C. For instance, the inlet temperature is about 250° C. and the outlet temperature about 350° C. The outlet is normally used to preheat the feed, in the present invention this feed being the CO₂/O₂-mixture, in a feed/effluent heat exchanger.

By the invention, a stream rich in methane (CH₄) such as a natural gas stream is combined with said CO₂-rich stream. This enables better control of hydrogen and oxygen slip. In the CATOX step, oxygen is consumed by reaction with all the hydrogen, and then subsequently, the remaining oxygen is consumed by the CH₄ present in the CO₂-rich stream. The natural gas stream may for instance be a portion of the hydrocarbon feed used to generate a shifted synthesis gas, as it will be explained farther below. It would be understood, that the CO₂-rich stream, stream rich in methane, and oxygen, may be combined in various ways, for forming the CO₂/O₂-mixture.

It would thus be understood that in step i), the term “thereby forming a CO₂/O₂-mixture” means a CO₂/O₂-mixture which also comprises hydrocarbons e.g. CH₄, hydrogen and/or CO.

In an embodiment according to the first aspect of the invention, the CATOX step is conducted in two or more steps with intermediate addition of oxygen. In a particular embodiment, the oxygen is provided by splitting an oxygen stream and feeding to the two or more steps, i.e. parallel feeding the oxygen to the CATOX units, for instance by mixing oxygen with a first stream exiting the first CATOX step prior to entering a subsequent or second CATOX step. This further enables better control of hydrogen and oxygen slip due to any excess of hydrogen and/or oxygen.

As used herein, the term “high purity CO₂-product” means a CO₂-product having a purity of as high as 99.8 vol.% CO₂ or even higher, for instance 99.99 vol.%. It would be understood that the CO₂ concentration of this high purity CO₂-product is higher than the CO₂ concentration of the CO₂-rich stream containing hydrocarbons, hydrogen and/or CO.

As used, herein, the term “CO₂-rich stream containing hydrocarbons, hydrogen and/or CO” means a stream with a significant content of CO₂, for instance 98 vol.% or higher and which also contains hydrocarbons such as CH₄, as well as CO and H₂. For instance, less than 0.05 vol.% CH₄, less than 0.05 vol.% CO, and less than 2 vol.% H₂.

The CO₂-rich stream is a stream having a significant content of CO₂, in particular as explained farther below, a stream separated from the low-pressure flash step of a carbon dioxide removal section and having a CO₂-concentration of 98 vol.% or higher such as 99 vol.%.

The invention enables the oxidation of H₂ to H₂O and subsequent removal of the H₂O to reduce the H₂ content in CO₂ product, as well of the oxidation of other components like hydrocarbons.

In an embodiment according to the first aspect of the invention, in step iii) the removing of H₂O comprises passing the purified stream to a cooling train including one or more cooling units for thereby producing a cooled purified stream, and subsequently passing the cooled purified stream to a condensing step, e.g. by passing the purified stream to a condensate separator, thereby separating water as a condensate phase. In a particular embodiment, the cooling train includes a first cooling unit for preheating said CO₂/O₂-mixture before the CATOX step, preferably in a feed/effluent heat exchanger. In a particular embodiment, the cooling train further includes a cooling unit using N₂ from an air separation unit (ASU), such as a heat exchanger using N₂ as the heat exchanging medium.

In an embodiment according to the first aspect of the invention, the oxygen is generated from an air separation unit (ASU) and/or a water/steam electrolysis unit, Hence, the ASU provides preferably also for the oxygen being mixed with the CO₂-rich stream prior to entering the catalytic oxidation step ii), as well as for the oxygen used in the reforming step where this reforming step includes autothermal reforming (ATR). Thereby, better integration and utilization of the streams produced in the ASU, i.e. not only O₂ for the ATR but also N₂ in the cooing train, is possible. In another embodiment, the oxygen being mixed with the CO₂-rich stream prior to entering the catalytic oxidation step ii) is generated by providing a water feedstock and passing it through an electrolysis unit, i.e. a water/steam electrolysis unit. In a particular embodiment, the electrolysis unit is an alkali/polymer electrolyte membrane electrolysis unit i.e. alkali/PEM electrolysis unit (alkaline cells or polymer cells units). Such electrolysis unit utilizes water. In another particular embodiment, the electrolysis unit is a solid oxide electrolysis unit. Such electrolysis utilizes steam. Thereby, a more sustainable process and plant is possible, since the power required for electrolysis may be provided by renewable sources such as wind and solar energy.

It will be understood, that the term water feedstock includes water or steam. It would also be understood, that the term water/steam means water or steam.

In an embodiment according to the first aspect of the invention, step iii) further comprises a drying step, preferably after conducting said condensing step. This drying step enables a final water removal to provide a substantially water-free purified stream. In a particular embodiment, the drying step is conducted in a temperature swing adsorption unit. This enables to achieve the highest CO₂ purity without increasing the carbon emission to the atmosphere. Temperature swing adsorption units are well-known in the art.

In an embodiment according to the first aspect of the invention, the CO₂-rich stream of step i) is derived from a CO₂-removal section, said CO₂-removal section being arranged to receive a shifted synthesis gas stream, in which the CO₂-removal section is an amine wash unit and comprises a CO₂-absorber, a CO₂-stripper and a low-pressure flash drum from which said CO₂-rich stream is separated. Hence, according to this embodiment the CO₂-rich stream is a product CO₂-stream derived from the low-pressure flash step. For instance, the overhead stream from the low-pressure flash drum, mainly containing carbon dioxide, may be subjected to a separating step in a CO₂-separator for thereby separate the CO₂-rich stream and a condensate stream which may be recycled to the low-pressure flash drum. In a particular embodiment, this CO₂-rich stream contains at least 98 vol.% CO₂, such as 98.5 vol.% or 99 vol.% CO₂.

In the CO₂-removal section, in particular an amine wash unit, it is normally desirable to have a high-pressure flash step prior to the low-pressure flash step. Yet, in another particular embodiment according to the first aspect of the invention, the CO₂-removal section is absent of a high-pressure flash step. This enables reduced complexity and costs associated with the CO₂-removal section, as the high-pressure flash drum (HP flash drum) can be omitted. In addition, while it is possible, when operating a CO₂ removal section with a HP flash drum, to recycle the HP flash gas back to the CO₂ absorber column of the CO₂ removal section, the rest of the impurities ends up in the CO₂-rich stream separated from the low-pressure flash drum. This results in a lower purity of the CO₂-rich stream than the one obtained by using CATOX in accordance with the present invention. The HP flash gas can also be burned releasing CO₂ to atmosphere, but purity of CO₂-rich stream will still be lower than with the present invention.

Hence, by using catalytic oxidation, the generated CO₂ which otherwise would be carried over in the high-pressure flash gas of the CO₂ removal section, is captured in the CO₂-rich stream separated from the low-pressure flash drum, thus increasing the flow of the CO₂-rich stream and avoiding the increase of CO₂ emission to the atmosphere. This is especially of interest for blue hydrogen where CO₂ emissions are required to be minimized. Other methods for purifying a CO₂ stream such as pressure swing adsorption, membrane filtration or cryogenic, results in a purified stream and an off-gas stream. The off-gas stream is usually burned releasing CO₂ to the atmosphere.

Particularly for hydrogen plants, where maximizing CO₂ capture is important, such as when producing blue hydrogen, the CATOX process purifies the CO₂ without increasing carbon emission. In all other processes, an off-gas stream is created which will lead to increased carbon emission if burned or it must be processed in some way.

Hence, the present invention uses CATOX to purify CO₂ while not increasing carbon emissions in the plant.

At least part of the low-pressure flash gas, for instance in the form of a purge stream, is subjected to the catalytic oxidation, thereby also avoiding the build-up of impurities. In the catalytic oxidation step, the impurities are catalytically oxidized to CO₂ and H₂O. The oxidation of the hydrogen in the gas generates the necessary heat for the CATOX step. The H₂O can be removed from the CO₂ stream by condensation followed by optionally drying in a unit such a as a temperature swing adsorption unit, as explained above.

In another embodiment according to the first aspect of the invention, the CO₂-removal section comprises a high-pressure flash drum, e.g. upstream said low-pressure flash drum, and the process further comprises adding hydrogen to said CO₂-rich stream. This enables the provision of a CO₂-removal section being able to generate the CO₂-rich stream derived from the low-pressure drum as well as a high-pressure flash gas stream which may be used e.g. in fired heaters used to preheat the hydrocarbon feed in the reforming. The added hydrogen to the CO₂-rich stream ensures thereby the provision of the necessary duty of the CATOX step(s). The hydrogen is suitably a stream derived from a H₂-rich stream withdrawn from the CO₂-removal section and/or a hydrogen stream derived from water/steam electrolysis

The high purity CO₂ product obtained by the process is preferably captured and transported for e.g. sequestration in geological structures, thereby reducing the CO₂ emission to the atmosphere.

Preferably, the CO₂-removal section is comprised in a process or plant for producing hydrogen, whereby a synthesis gas generated by steam reforming (here interchangeably used with the term reforming) is subjected to water gas shift to form said shifted synthesis gas stream and subsequently to CO₂-removal in a CO₂-removal section.

Accordingly, in an embodiment according to the first aspect of the invention, step i) i.e. the step including providing a CO₂-rich stream containing hydrocarbons, hydrogen and/or CO, comprises:
supplying a hydrocarbon feed to a reforming section, and converting it to a stream of synthesis gas;
withdrawing a stream of synthesis gas from the reforming section and supplying it to a shift section, shifting the synthesis gas in a high temperature shift (HTS)-step, and optionally also in a medium temperature shift (MTS) and/or low temperature shift (LTS)-shit step, thereby providing a shifted synthesis gas stream;
supplying the shifted synthesis gas stream from the shift section to a CO₂ removal section, suitably said amine wash unit, and separating said CO₂-rich stream from said shifted synthesis gas stream, thereby providing a H₂-rich stream.

Thus, from the CO₂-removal section, not only a CO₂-rich stream containing hydrocarbons, hydrogen and/or CO is generated, but also a H₂-rich stream.

As used herein, the term H₂-rich stream means a stream containing 95 vol.% or more, for instance 98 vol.% or more hydrogen, i.e. having a hydrogen purity of above 95 vol.%, with the balance being minor amounts of carbon containing compounds CH₄, CO, CO₂, as well as inerts N₂, Ar.

Synthesis gas is typically produced by reforming a hydrocarbon feed either by steam reforming (SMR), secondary reforming, such as autothermal reforming (ATR) and two-step reforming with SMR and ATR in series. The SMR is advantageously an electrically heated steam reformer (e-SMR, or interchangeably, e-reformer), as for instance disclosed in applicant’s Patent Application WO 2019/228797A1 . A stand-alone ATR which may also include the use of a pre-reformer, is particularly suitable for the production of a H₂-rich stream in accordance with the invention.

Accordingly, in a particular embodiment, the reforming section comprises autothermal reforming (ATR). In another particular embodiment, the reforming section further comprises pre-reforming said hydrocarbon feed in one or more prereformer units prior to it being fed to the ATR.

Thus, preferably the process or plant is without i.e. is absent of, a steam methane reformer unit (SMR) upstream the ATR. Accordingly, the reforming may include prereforming, yet it is conducted without primary reforming i.e. without a primary reforming unit. Thereby, a reduction in plant size is achieved.

In a particular embodiment, the process further comprises preheating said hydrocarbon feed in one or more fired heaters and feeding at least a part of said H₂-rich stream as hydrocarbon fuel to the at least one or more fired heaters.

By using part of the H₂-rich stream as fuel, i.e. as low carbon hydrogen fuel, it is possible, in a simple manner, to decarbonize the hydrocarbon feed, this for instance being natural gas, whereby at least 95% of the carbon is captured, while still achieving a high hydrogen purity in the H₂-rich stream.

In an embodiment according to the first aspect of the invention, the process further comprises providing a hydrogenation unit and a sulfur absorption unit for conditioning the hydrocarbon feed, e.g. for sulfur removal, prior to said prereforming or prior to passing to said ATR, and mixing a portion of the H₂-rich stream, i.e. as H₂-recyle, with the hydrocarbon feed before being fed to the hydrogenation unit.

It would be understood that the reforming section is the section of the plant comprising units up to and including the ATR, i.e. the ATR, or the one or more pre-reformer units and the ATR. The reforming section may also comprise a hydrogenation unit and sulfur absorber upstream the one or more pre-reformer units and ATR.

The air separation unit (ASU) is arranged for receiving an air stream and produce an oxygen comprising stream which is then fed through a conduit to the ATR. Preferably, the oxygen comprising stream contains steam added to the ATR in accordance with the above-mentioned embodiment. Examples of oxidant comprising stream are: oxygen; mixture of oxygen and steam; mixtures of oxygen, steam, and argon; and oxygen enriched air. In the ASU, a nitrogen stream is also produced, which advantageously may also be used in the process and plant of the invention, as explained above.

The temperature of the synthesis gas at the exit of the ATR is between 900 and 1100° C., or 950 and 1100° C., typically between 1000 and 1075° C. This hot effluent synthesis gas which is withdrawn from the ATR (syngas from the ATR) comprises carbon monoxide, hydrogen, carbon dioxide, steam, residual methane, and various other components including nitrogen and argon.

Autothermal reforming (ATR) is described widely in the art and open literature. Typically, the ATR comprises a burner, a combustion chamber, and catalyst arranged in a fixed bed all of which are contained in a refractory lined pressure shell. ATR is for example described in Chapter 4 in “Studies in Surface Science and Catalysis”, Vol. 152 (2004) edited by Andre Steynberg and Mark Dry, and an overview is also presented in “Tubular reforming and autothermal reforming of natural gas - an overview of available processes”, lb Dybkjær, Fuel Processing Technology 42 (1995) 85-107.

Preferably steam is added upstream the HTS unit. Steam may optionally be added after the high temperature shift step such as before one or more following MT or LT shift and/or HT shift steps in order to maximize the performance of said following HT, MT and/or LT shift steps. The catalysts and process for conducting HTS, MTS and LTS are well known in the art.

In an embodiment according to the first aspect of the invention, the process is absent of a hydrogen purification step, such as pressure swing adsorption (PSA). Thereby there is no need for handling off-gas, e.g. a PSA off-gas, by for instance burning-off or flaring, thereby further reducing CO₂-emissions. In a particular embodiment, the process is absent of a hydrogen purification step such as pressure swing adsorption (PSA) after said CO₂-removal section. Thereby, the process and/or plant is further simplified, and plant size being reduced.

In a second aspect of the invention, there is also provided a plant, i.e. process plant, for producing a high purity CO₂ product stream, said plant comprising:
a conduit for mixing an oxygen stream, preferably oxygen generated from an air separation unit (ASU) and/or a water/steam electrolysis unit, with a CO₂-rich stream containing hydrocarbons, hydrogen and/or CO; and a conduit for combining a stream rich in methane (CH₄), such as a natural gas stream, with said CO₂-rich stream; thereby forming an inlet gas comprising a mixture of carbon dioxide and oxygen;
a catalytic oxidation (CATOX) unit arranged to receive said inlet gas comprising a mixture of carbon dioxide and oxygen, said CATOX unit comprising an outlet for withdrawing an outlet gas as a purified stream having a higher CO₂ and H₂O concentration;
a cooling train arranged to receive said outlet from the CATOX unit, said cooling train comprising one or more cooling units for cooling the outlet gas;
a condensate separator arranged to receive the thus cooled outlet gas and for removing H₂O, thereby forming an outlet product comprising said high purity CO₂ product stream.

In a third aspect of the invention, there is also provided the surprising use of a CATOX unit for purifying a CO₂-rich stream containing hydrocarbons, hydrogen and/or CO, which is derived from a process or plant for producing hydrogen, in particular from a CO₂-removal section thereof, while not increasing the carbon emission of the plant

In an embodiment according to the third aspect of the invention, said process comprises:
supplying a hydrocarbon feed to a reforming section, and converting it to a stream of synthesis gas;
withdrawing a stream of synthesis gas from the reforming section and supplying it to a shift section, shifting the synthesis gas in a high temperature shift (HTS)-step, and optionally also in a medium temperature shift (MTS) and/or low temperature shift (LTS)-shit step, thereby providing a shifted synthesis gas stream;
supplying the shifted synthesis gas stream from the shift section to said CO₂ removal section, suitably an amine wash unit, and separating said CO₂-rich stream from said shifted synthesis gas stream, thereby providing a H₂-rich stream.

In another embodiment according to the third aspect of the invention, the invention encompasses also a plant for carrying out said process, i.e. the plant comprises a reforming section, a shift section and said CO₂-removal section.

Suitably also, the process or plant is absent of a hydrogen purification unit, such as pressure swing adsorption (PSA) unit, for instance a PSA unit downstream the CO₂-removal section.

It would be understood that any of the embodiments and associated benefits of the first aspect of the invention may be used in connection with any of the embodiments of the second and third aspect of the invention, and vice versa.

The accompanying figure illustrates a layout of an ATR-based hydrogen process and plant with further purification of a CO₂-rich stream according to one embodiment of the invention.

With reference to the figure, there is shown a plant/process 100 in which a hydrocarbon feed 1, such as natural gas, is passed to a reforming section comprising a pre-reforming unit 140 and ATR 110. The reforming section may also include a hydrogenator and sulfur absorber unit (not shown) upstream the pre-reforming unit 140. Prior to entering the hydrogenator, the hydrocarbon steam 1 is mixed with a hydrogen-recycle stream 8‴ diverted from a H₂-rich stream 8 produced in downstream CO₂-removal section 170. Prior to entering the pre-reforming unit 140, the hydrocarbon feed 1 is also mixed with steam 13 and the resulting prereformed hydrocarbon feed 2 is fed to the ATR 110, as so is an oxidant stream formed by mixing oxygen 15 and steam 13. Steam may also be added separately, as also shown in the figure. The oxygen stream 15 is produced by an air separation unit (ASU) 145 to which air 14 is fed. In the ATR 110, the hydrocarbon feed 2 is converted into a stream of synthesis gas 3, which is withdrawn from the ATR 110 and passed to a shift section. This syngas exits the ATR through a refractory lined outlet section and transfer line to waste heat boilers (not shown) in the syngas i.e. process gas cooling section.

The shift section comprises a high temperature shift (HTS) unit 115 where additional or extra steam 13′ also may be added upstream. Additional shift units, such as a low temperature shift (LTS) unit 150 may also be included in the shift section. Additional or extra steam may also be added downstream the HTS unit 115 yet upstream the LTS unit 150 for increasing the steam-to-carbon ratio. From the shift section, a shifted synthesis gas stream 5 enriched in hydrogen is produced which is then fed to a CO₂-removal section 170. The CO₂-removal section 170 comprises a CO₂-absorber and a CO₂-stripper (regenerator), which separates a CO₂-rich stream 10 derived from a low-pressure flash drum (not shown) and which contains e.g. more than 99 vol.% CO₂, and hydrocarbons such as CH₄, as well as CO and H₂. A H₂-rich stream 8 containing e.g. 98 vol.% hydrogen or higher is also withdrawn from the CO₂-removal section 170. Optionally, a high-pressure flash gas 12 from a high-pressure flash drum (not shown) of the CO₂-removal section 170 may be generated. The plant 100, as illustrated in the figure,is absent of a hydrogen purification unit, such as a PSA.

The H₂-rich stream 8 is divided into a H₂-product 8′ for supplying to end customers such as refineries, a low carbon hydrogen fuel 8″ which is used in fired heater unit(s) 135, and a hydrogen-recycle 8‴ for mixing with the hydrocarbon feed 1. The fired heater 135 provides for the indirect heating of hydrocarbon feed 1 and optionally also hydrocarbon feed 2.

The CO₂-rich stream 10 is compressed (not shown), combined e.g. mixed with a portion of natural gas being feed in line 1 (not shown) or a separate natural gas stream (not shown), and mixed with oxygen stream 15 from the ASU, thereby forming a CO₂/O₂-mixture stream 17. The CO₂/O₂-mixture is preheated in a CATOX feed/effluent heat exchanger 180, thus forming a preheated stream 18 which is then passed to the CATOX unit 190. From the CATOX unit 190, catalytic oxidation over e.g. a fixed bed of catalyst, as is well known in the art, is conducted thereby producing a purified stream 19 having a higher CO₂ and H₂O concentration than the CO₂-rich stream 10 stream prior to or after combining with the stream rich in methane, or higher than in the CO₂/O₂-mixture stream 17 and 18. This purified stream 19 is withdrawn and used as heat exchanging medium in the feed/effluent heat exchanger 180. The thus cooled purified stream 20 is further cooled in cooling train 200, which may comprise a CO₂ air cooler and CO₂ water cooler (not shown) as well as a heat exchanger using nitrogen 16 from the ASU as cooling medium. The nitrogen is then withdrawn as stream 21, while water is removed from the further cooled purified stream 22 as condensed stream 23 in condensate separator 210, thereby forming a high purity CO₂ product stream 24 having a CO₂ concentration of e.g. 99.9 vol.% or 99.99 vol.% or even higher.

1. A process for producing a high purity CO₂ product, comprising the steps of:
i) providing a CO₂-rich stream containing hydrocarbons, hydrogen and/or CO; combining it with a stream rich in methane (CH₄); and mixing it with oxygen, thereby forming a CO₂/O₂- mixture;
ii) subjecting the CO₂/O₂- mixture to a catalytic oxidation step, thereby producing a purified stream having a higher CO₂ and/or H₂O concentration;
iii) removing H₂O from said purified stream, for producing said high purity CO₂ product.

2. The process of claim 1, wherein the catalytic oxidation step is conducted in two or more steps with intermediate addition of oxygen.

3. The process of claim 1, wherein in step iii) the removing of H₂O comprises passing the purified stream to a cooling train including one or more cooling units for thereby producing a cooled purified stream, and subsequently passing the cooled purified stream to a condensing step.

4. The process of claim 3, wherein the cooling train includes a cooling unit using N₂ from an air separation unit (ASU).

5. The process of claim 1, wherein the oxygen is generated from an air separation unit (ASU) and/or a water/steam electrolysis unit.

6. The process of claim 1, wherein step iii) further comprises a drying step, preferably after conducting said condensing step.

7. The process of claim 6, wherein said drying step is conducted in a temperature swing adsorption unit.

8. The process of claim 1, wherein the CO₂-rich stream of step i) is derived from a CO₂-removal section, said CO₂-removal section being arranged to receive a shifted synthesis gas stream, in which the CO₂-removal section is an amine wash unit and comprises a CO₂-absorber, a CO₂₋stripper and a low-pressure flash drum, from which said CO₂-rich stream is separated.

9. The process of claim 8, wherein the CO₂-removal section comprises a highpressure flash drum and the process further comprises adding hydrogen to said CO₂-rich stream.

10. The process of claim 1, wherein step i) comprises:
supplying a hydrocarbon feed to a reforming section, and converting it to a stream of synthesis gas;
withdrawing a stream of synthesis gas from the reforming section and supplying it to a shift section, shifting the synthesis gas in a high temperature shift (HTS)-step, and optionally also in a medium temperature shift (MTS) and/or low temperature shift (LTS)-shit step, thereby providing a shifted synthesis gas stream;
supplying the shifted synthesis gas stream from the shift section to a CO₂ removal section, suitably said amine wash unit, and separating said CO₂-rich stream from said shifted synthesis gas stream, thereby providing a H₂-rich stream.

11. The process of claim 10, wherein the reforming section comprises autothermal reforming (ATR), and optionally also pre-reforming said hydrocarbon feed in one or more prereformer units prior to it being fed to the ATR.

12. The process of claim 10, further comprising preheating said hydrocarbon feed in one or more fired heaters and feeding at least a part of said H₂-rich stream as hydrocarbon fuel to the at least one or more fired heaters.

13. The process of claim 1, wherein the process is absent of a hydrogen purification step.

14. A plant for producing a high purity CO₂ product, said plant comprising:
a conduit for mixing an oxygen stream, preferably oxygen generated from an air separation unit (ASU) and/or a water/steam electrolysis unit, with a CO₂-rich stream containing hydrocarbons, hydrogen and/or CO; and a conduit for combining a stream rich in methane (CH₄), with said CO₂-rich stream; thereby forming an inlet gas comprising a mixture of carbon dioxide and oxygen;
a catalytic oxidation (CATOX) unit arranged to receive said inlet gas comprising a mixture of carbon dioxide and oxygen, said CATOX unit comprising an outlet for withdrawing an outlet gas as a purified stream having a higher CO₂ and/or H₂O concentration;
a cooling train arranged to receive said outlet gas from the CATOX unit, said cooling train comprising one or more cooling units for cooling the outlet gas;
a condensate separator arranged to receive the thus cooled outlet gas and for removing H₂O, thereby forming an outlet product comprising said high purity CO₂ product.

15. Use of a CATOX unit for purifying a CO₂-rich stream containing hydrocarbons, hydrogen and/or CO, which is derived from a process or plant for producing hydrogen, in particular from a CO₂-removal section thereof, while not increasing the carbon emission of the plant.
